(19) United States
(12) Patent Application Publication
(10) Pub. No.: US 2013/0210438 A1
(43) Pub. Date: Aug. 15, 2013

(54) CELL-BASED INTER-FREQUENCY MEASUREMENT EVENTS FOR DETECTED OR MONITORED SET CELLS

(71) Applicants: Brian Martin, Farnham (GB); Keiichi Kubota, Weybridge (GB); Mitsuya Saito, Camberley (GB)

(72) Inventors: Brian Martin, Farnham (GB); Keiichi Kubota, Weybridge (GB); Mitsuya Saito, Camberley (GB)

(73) Assignee: NOKIA CORPORATION, Espoo (FI)

(21) Appl. No.: 13/817,343

(22) PCT Filed: Aug. 11, 2011
(86) PCT No.: PCT/FI2011/050712

§ 371 Date: May 1, 2013

Related U.S. Application Data
(60) Provisional application No. 61/374,016, filed on Aug. 16, 2010.

(51) Int. Cl. H04W 36/00

(52) U.S. Cl. CPC H04W 36/0061
USPC 455/436

(57) ABSTRACT

A method, apparatus and computer program product are provided to permit a neighbor list to be updated, such as by removing a monitored cell or adding a detected cell. The method determines that a monitored cell that is on the neighbor list or a detected cell that is not on the neighbor list satisfies predetermined criteria defining an event. The method also causes information to be provided regarding the monitored cell or detected cell in response to the event, and then receives a message adding the detected cell to the neighbor list or removing the monitored cell from the neighbor list. Once a detected cell is added to the neighbor list, the method may use the detected cell to determine a frequency quality estimate, use the detected cell for inter-frequency measurements or consider the detected cell for inclusion in a virtual active set.

### TECHNICAL FIELD

Example embodiments of the present invention generally relate to cellular networks and, more particularly, relate to managing a list of neighbor cells based on one or more detected cells outside of the list.

### BACKGROUND

During network configuration or other network planning exercises, a neighbor list may be defined that identifies a plurality of cells that may be capable of supporting communications between a user equipment (UE) and the network. The cells included within the neighbor list may include cells that operate at the frequency that is currently used by the UE, as well as cells that operate at a different frequency that is not currently used by the UE, but that may also support communications between the UE and the network.

In operation, the UE may monitor the performance, such as the signal strength, of the first cell that is supporting communications between the UE and the network as well as a number of other cells. Based upon the relative performance of the cells as well as a number of other factors, the UE may be handed over from the first cell to another cell included within the neighbor list such that the other cell then begins to support communications between the UE and the network. For example, the UE may be handed over from the first cell to the other cell in instances in which the performance of the other cell exceeds that of the first cell. In instances in which the other cell operates at a different frequency than the first cell, the hand over may result in the communications between the UE and the network not only being supported by a different cell, but also being conducted at a different frequency.

### BRIEF SUMMARY

In one embodiment, a method is provided that comprises determining that a monitored cell or detected cell satisfies predetermined criteria defining an event, where the monitored cell is on a neighbor list and the detected cell is not on a neighbor list, and each of the detected cell and monitored cell has a different frequency than a frequency currently in use. The method also comprises causing information to be provided regarding the monitored cell or detected cell in response to the event, and receiving a message adding the detected cell to the neighbor list or removing the monitored cell from the neighbor list in response to causing the information to be provided. Once a detected cell is added to the neighbor list, the method may comprise at least one of using the detected cell to determine a frequency quality estimate, using the detected cell for inter-frequency measurements or considering the detected cell for inclusion in a virtual active set.

In another embodiment, an apparatus is provided which includes at least one processor and at least one memory storing computer program code. The at least one memory and the stored computer program code are configured, with the at least one processor, to cause the apparatus to at least determine that a monitored cell or detected cell satisfies predetermined criteria defining an event, where the monitored cell is on a neighbor list and the detected cell is not on a neighbor list, and each of the detected cell and monitored cell has a different frequency than the frequency currently in use. The at least one memory and the stored computer program code may also be configured, with the at least one processor, to cause the apparatus to cause information to be provided regarding the monitored cell or detected cell in response to the event, and receive a message adding the detected cell to the neighbor list or removing the monitored cell from the neighbor list in response to the information being provided. Once a detected cell is added to the neighbor list, the at least one memory and the stored computer program code may also be configured, with the at least one processor, to cause the apparatus to use the detected cell to determine a frequency quality estimate, use the detected cell for inter-frequency measurements or consider the detected cell for inclusion in a virtual active set.

In another embodiment, a computer program product is provided that includes at least one computer-readable medium having computer-readable program instructions stored therein. The computer-readable program instructions include program instructions configured to determine that a monitored cell or detected cell satisfies predetermined criteria defining an event, where the monitored cell is on a neighbor list and the detected cell is not on a neighbor list, and each of the detected cell and monitored cell has a different frequency than a frequency currently in use. The computer-readable program instructions may include program instructions configured to cause information to be provided regarding the monitored cell or detected cell in response to the event, and to receive a message adding the detected cell to the neighbor list or removing the monitored cell from the neighbor list in response to causing the information to be provided. Once a detected cell is added to the neighbor list, the computer-readable program instructions may include program instructions configured to use the detected cell to determine a frequency quality estimate, use the detected cell for inter-frequency measurements or consider the detected cell for inclusion in a virtual active set.

In another embodiment, an apparatus is provided that comprises means for determining that a monitored cell or detected cell satisfies predetermined criteria defining an event, where the monitored cell is on a neighbor list and the detected cell is not on a neighbor list, and each of the detected cell and monitored cell has a different frequency than a frequency currently in use. The apparatus also comprises means for causing information to be provided regarding the monitored cell or detected cell in response to the event, and means for receiving a message adding the detected cell to the neighbor list or removing the monitored cell from the neighbor list in response to causing the information to be provided. Once a detected cell is added to the neighbor list, the apparatus may comprise means for using the detected cell to determine a frequency quality estimate, means for using the detected cell for inter-frequency measurements or means for considering the detected cell for inclusion in a virtual active set.

Examples of events may be that a measurement of the detected cell enters a reporting range, or that a measurement of the monitored cell leaves a reporting range. Other examples of events may be that a measurement of the detected cell is greater than a threshold, or that a measurement of the monitored cell is greater than a threshold. And yet another example of an event may be that a measurement of the detected cell is greater than a corresponding measurement of another cell on the neighbor list, the respective other cell having the same frequency as the detected cell.

### BRIEF DESCRIPTION OF THE DRAWING(S)

Having thus described example embodiments of the invention in general terms, reference will now be made to the accompanying drawings, which are not necessarily drawn to scale, and wherein:

FIG. 1 illustrates a heterogeneous communication system according to various example embodiments of the present invention;

FIG. 2 illustrates a public land mobile network according to various example embodiments of the present invention;

FIG. 3 illustrates an apparatus that may be configured to operate within the system of FIG. 1, according to various example embodiments of the present invention;

FIGS. 4-8 are graphs illustrating aspects of cell-based inter-frequency measurement events, according to example embodiments of the present invention;

FIG. 9 is a control flow diagram illustrating a message sequence for operation of an inter-frequency measurement event, according to example embodiments of the present invention; and

FIG. 10 is a flowchart illustrating various operations in a method according to an example embodiment of the present invention.

### DETAILED DESCRIPTION

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. Reference may be made herein to terms specific to a particular system, architecture or the like, but it should be understood that example embodiments of the present invention may be equally applicable to other similar systems, architectures or the like.

The terms “data,” “content,” “information,” and similar terms may be used interchangeably, according to some example embodiments of the present invention, to refer to data capable of being transmitted, received, operated on, and/or stored. The term “network” may refer to a group of interconnected computers or other computing devices. Within a network, these computers or other computing devices may be interconnected directly or indirectly by various means including via one or more switches, routers, gateways, access points or the like.

Further, as used herein, the term “circuitry” refers to any or all of the following: (a) hardware-only circuit implementations (such as implementations in only analog and/or digital circuitry); (b) to combinations of circuits and software (and/or firmware), such as (as applicable): (i) a combination of processor(s) or (ii) portions of processor(s)/software (including digital signal processor(s)), software and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Further, as described herein, various messages or other communication may be transmitted or otherwise sent from one component or apparatus to another component or apparatus. It should be understood that transmitting a message or other communication may include not only transmission of the message or other communication, but may also include preparation of the message or other communication by a transmitting apparatus or various means of the transmitting apparatus.

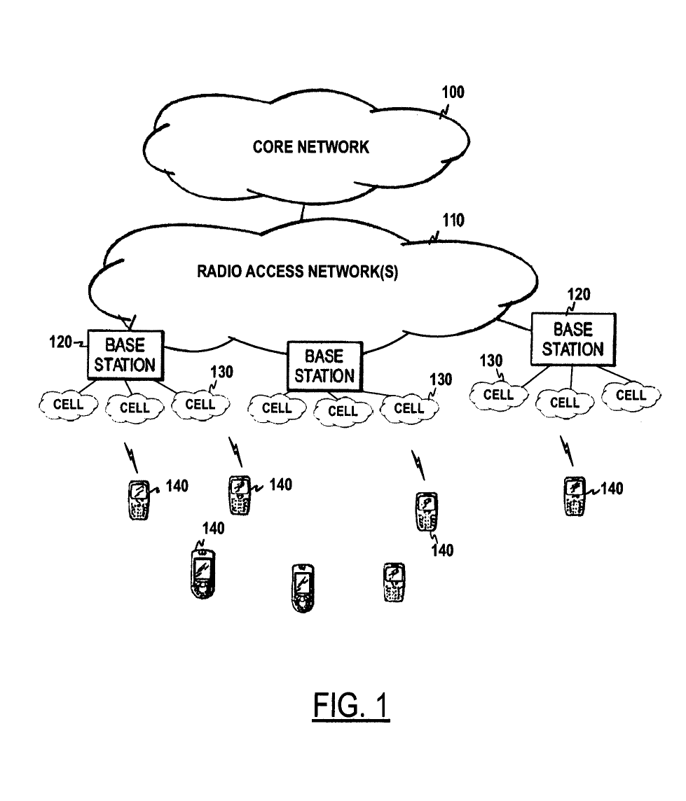

FIG. 1 depicts a heterogeneous communications system according to various example embodiments of the present invention. Generally, the system includes one or more public land mobile networks (PLMNs) coupled to one or more other data or communication networks—notably a wide area network (WAN) such as the Internet. As shown, each of the PLMNs includes a core network 100 backbone such as the Evolved Packet Core (EPC); and each of the core networks and the Internet are coupled to one or more radio access networks 110, air interfaces or the like that implement one or more radio access technologies. As shown, the radio access networks each include one or more base stations 120 (or node B elements), access points or the like, each of which may serve a coverage area divided into one or more cells 130.

In addition, the system includes one or more mobile radio units that may be varyingly known as user equipment (UE) 140, terminal equipment, mobile station, mobile terminal or the like. As a mobile terminal, the UE may be a mobile computer, mobile telephone, a portable digital assistant (PDA), a pager, a mobile television, a gaming device, a mobile computer, a laptop computer, a camera, a video recorder, an audio/video player, a radio, and/or a global positioning system (GPS) device, any combination of the aforementioned, or the like. In operation, these UEs may be configured to connect to one or more of the radio access networks 110 according to their particular radio access technologies to thereby access a particular core network of a PLMN, or to access one or more of the other data or communication networks (e.g., the Internet). In various instances, a single UE, a dual-mode or multimode UE, may support multiple (two or more) radio access networks—thereby being configured to connect to multiple radio access networks. For example, a particular UE may support both Global System for Mobile communications (GSM) and Universal Mobile Telecommunications System (UMTS) radio access technologies.

Examples of radio access technologies include 3^{rd} Generation Partnership Project (3GPP) radio access, Universal Mobile Telephone System (UMTS) radio access UTRAN (Universal Terrestrial Radio Access Network), GSM radio access, Code Division Multiple Access (CDMA) 2000 radio access, Wireless Local Area Networks (WLANs) such as IEEE 802.xx networks (e.g., 802.11a, 802.11b, 802.11g, 802.11n, etc.), world interoperability for microwave access (WiMAX) networks, IEEE 802.16, and/or wireless Personal Area Networks (WPANs) such as IEEE 802.15, Bluetooth, low power versions of Bluetooth, ultra wideband (UWB), Wibree, Zigbee or the like. 3GPP radio access technologies may include, for example, 3^{rd} generation (3G) or 3.9G (also referred to as UTRAN Long Term Evolution (LTE) or Super 3G) or E-UTRAN (Evolved UTRAN). Generally, a radio access technology may refer to any 2^{nd} generation (2G), 3G, 4^{th} generation (4G) or higher generation mobile communication technology and their different versions, as well as to any other wireless radio access technology that may be arranged to interwork with such a mobile communication technology.

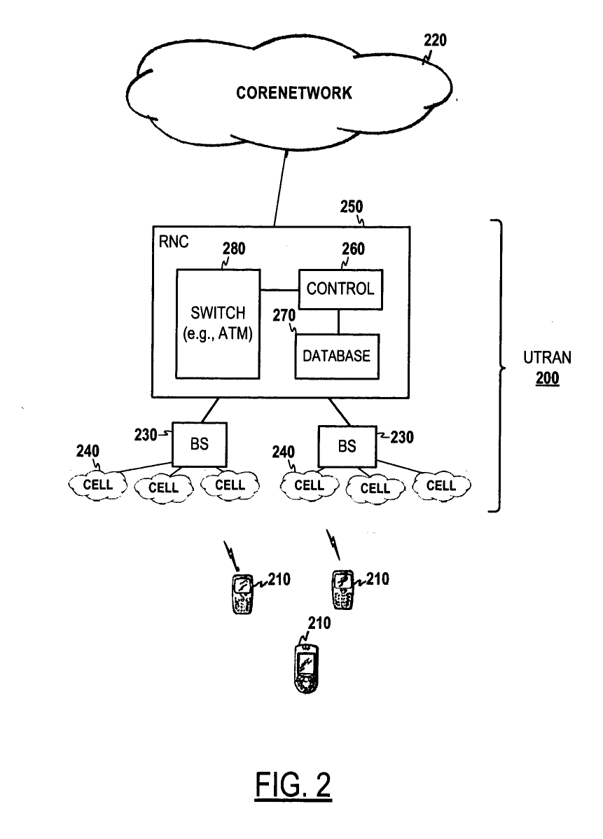

Referring now to FIG. 2, a PLMN including a UTRAN is more particularly illustrated according to various example embodiments of the present invention. In this regard, example embodiments of the present invention may be particularly described with respect to UTRAN. More information on aspects of UTRAN may be found, for example, in 3GPP TS 25.331 v.10.0.0 (2010-06), entitled: Radio Resource Control (RRC): Protocol Specification (Release 10), the content of which is incorporated by reference in its entirety. It should be understood, however, that example embodiments may be equally applicable to other radio access technologies.

The UTRAN 200, which is one of the 3rd Generation Wireless Mobile Communication Technologies, can carry many traffic types from real-time circuit switched (CS) to Internet Protocol (IP)-based packet switched (PS) traffic. The UTRAN allows connectivity between the UE 210 and the core network 220. UMTS may use wideband code division multiple access (WCDMA). The UTRAN contains the base stations (BSs) 230, called Node Bs, each of which serves a coverage area divided into cell(s) 240. As shown, UE 210, core network 220, BS 230 and cell 240 are examples of respective ones of UE 140, core network 100, base station 120 and cell 130 of FIG. 1.

The UTRAN 200 may also include radio network controllers (RNCs) 250, each of which may provide control functionalities for one or more Node Bs. A Node B 230 and an RNC can be the same device, although typical implementations have a separate RNC located in a central office serving multiple Node Bs. Despite the fact that they do not have to be physically separated, there is a logical interface between them. The RNC and its corresponding Node Bs are called the radio network subsystem (RNS). There can be more than one RNS present in an UTRAN.

As also shown, a radio access network 110 may more generally include some type of network controlling/governing entity, such as the RNC 250 in UTRAN 200, which may be responsible for control of the BSs 230 (e.g., Node Bs) that are connected to the controller. As used herein, the term “network controller” or “network controlling/governing entity” may refer to any network element or a set of network elements configured to use inter-radio access technology measurements for a network decision. Such a network controlling/governing entity may also include a BS or a Node-B. The network controlling/governing entity may include a controller 260, processor or the like programmed to carry out radio resource management and mobility management functions, etc. The controller may be associated with a memory or database 270 for maintaining information required in the management functions. The network controlling/governing entity may include a switch unit 280 (such an Asynchronous Transfer Mode (ATM) switch) for switching connection between network elements within the radio access network. The network controlling/governing entity may be connected to a Circuit Switched Core Network through e.g., Media Gateway (MGW) and to e.g., a Serving General Packet Radio Service (GPRS) Support Node (SGSN) in a Packet Switched Core Network.

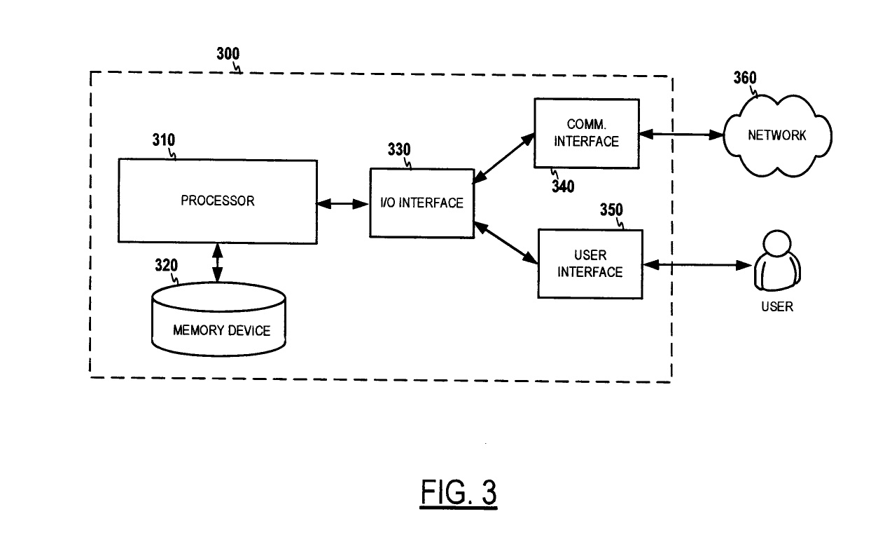

Reference is now made to FIG. 3, which illustrates an apparatus 300 according to example embodiments of the present invention configured to perform the various functionalities described herein. As shown and described herein, the example apparatus may be configured to function as or otherwise implement one or more of the network components depicted in FIG. 1 or 2 (e.g., BS 120, 230; UE 140, 210). The example apparatus depicted in FIG. 3 may also be configured to perform example methods of the present invention.

In some example embodiments, the apparatus 300 may, be embodied as, or included as a component of, a communications device with wired or wireless communications capabilities. In this regard, the apparatus may be configured to operate in accordance with the functionality of one or more network elements as described herein. The example apparatus may include or otherwise be in communication with one or more processors 310, memory devices 320, Input/Output (I/O) interfaces 330, communications interfaces 340 and/or user interfaces 350 (one of each being shown). The processor may be embodied as various means for implementing the various functionalities of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, the processor may be representative of a plurality of processors, or one or more multiple core processors, operating in concert. Further, the processor may be comprised of a plurality of transistors, logic gates, a clock (e.g., oscillator), other circuitry, and the like to facilitate performance of the functionality described herein. The processor may, but need not, include one or more accompanying digital signal processors. In some example embodiments, the processor is configured to execute instructions stored in the memory device or instructions otherwise accessible to the processor. The processor may be configured to operate such that the processor causes the apparatus to perform various functionalities described herein.

Whether configured as hardware or via instructions stored on a computer-readable storage medium, or by a combination thereof, the processor 310 may be an entity capable of performing operations according to embodiments of the present invention while configured accordingly. Thus, in example embodiments where the processor is embodied as, or is part of, an ASIC, FPGA, or the like, the processor is specifically configured hardware for conducting the operations described herein. Alternatively, in example embodiments where the processor is embodied as an executor of instructions stored on a computer-readable storage medium, the instructions specifically configure the processor to perform the algorithms and operations described herein. In some example embodiments, the processor is a processor of a specific device configured for employing example embodiments of the present invention by further configuration of the processor via executed instructions for performing the algorithms, methods, and operations described herein.

The memory device 320 may be one or more computer-readable storage media that may include volatile and/or non-volatile memory. In some example embodiments, the memory device includes Random Access Memory (RAM) including dynamic and/or static RAM, on-chip or off-chip cache memory, and/or the like. Further, the memory device may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. The memory device may include a cache area for temporary storage of data. In this regard, at least a portion or the entire memory device may be included within the processor 310.

Further, the memory device 320 may be configured to store information, data, applications, computer-readable program code instructions, and/or the like for enabling the processor 310 and the example apparatus 300 to carry out various functions in accordance with example embodiments of the present invention described herein. For example, the memory device may be configured to buffer input data for processing by the processor. Additionally, or alternatively, the memory device may be configured to store instructions for execution by the processor. The memory may be securely protected, with the integrity of the data stored therein being ensured. In this regard, data access may be checked with authentication and authorized based on access control policies.

The I/O interface 330 may be any device, circuitry, or means embodied in hardware, software or a combination of hardware and software that is configured to interface the processor 310 with other circuitry or devices, such as the communications interface 340 and/or the user interface 350. In some example embodiments, the processor may interface with the memory device via the I/O interface. The I/O interface may be configured to convert signals and data into a form that may be interpreted by the processor. The I/O interface may also perform buffering of inputs and outputs to support the operation of the processor. According to some example embodiments, the processor and the I/O interface may be combined onto a single chip or integrated circuit configured to perform, or cause the apparatus 300 to perform, various functionalities of the present invention.

The communication interface 340 may be any device or means embodied in hardware, software or a combination of hardware and software that is configured to receive and/or transmit data from/to one or more networks 360 (e.g., radio access networks 110, core networks 120, 220, etc.) and/or any other device or module (e.g., other similar apparatuses) in communication with the example apparatus 300. The processor 310 may also be configured to facilitate communications via the communications interface by, for example, controlling hardware included within the communications interface. In this regard, the communication interface may include, for example, one or more antennas, a transmitter, a receiver, a transceiver and/or supporting hardware, including, for example, a processor for enabling communications. Via the communication interface, the example apparatus may communicate with various other network elements in a device-to-device fashion and/or via indirect communications.

The communications interface 340 may be configured to provide for communications in accordance with any of a number of wired or wireless communication standards. The communications interface may be configured to support communications in multiple antenna environments, such as multiple input multiple output (MIMO) environments. Further, the communications interface may be configured to support orthogonal frequency division multiplexed (OFDM) signaling. In some example embodiments, the communications interface may be configured to communicate in accordance with various techniques including, as explained above, any of a number of 2G, 3G, 4G or higher generation mobile communication technologies, radio frequency (RF), infrared data association (IrDA) or any of a number of different wireless networking techniques. The communications interface may also be configured to support communications at the network layer, possibly via Internet Protocol (IP).

The user interface 350 may be in communication with the processor 310 to receive user input via the user interface and/or to present output to a user as, for example, audible, visual, mechanical or other output indications. The user interface may include, for example, a keyboard, a mouse, a joystick, a display (e.g., a touch screen display), a microphone, a speaker, or other input/output mechanisms. Further, the processor may comprise, or be in communication with, user interface circuitry configured to control at least some functions of one or more elements of the user interface. The processor and/or user interface circuitry may be configured to control one or more functions of one or more elements of the user interface through computer program instructions (e.g., software and/or firmware) stored on a memory accessible to the processor (e.g., the memory device 320). In some example embodiments, the user interface circuitry is configured to facilitate user control of at least some functions of the apparatus 300 through the use of a display and configured to respond to user inputs. The processor may also comprise, or be in communication with, display circuitry configured to display at least a portion of a user interface, the display and the display circuitry configured to facilitate user control of at least some functions of apparatus.

Referring again to FIG. 2, a UE 210 may receive simultaneously communication service from a number of BSs 230 on a used frequency, with each BS assigning the UE one or more downlink dedicated physical channels (DPCH) in a respective one or more cells 240. These cell(s) to which the UE may be simultaneously connected may be defined as an active set. In the system, the UE may be handed over between cells according to a process controlled by a list of available cells, referred to as a neighbor cell list and, according to UTRAN, more particularly stored in a CELL_INFO_LIST.

The neighbor cell list may include the active set and may also include a set of cells, referred to as a monitored set, which the UTRAN 200 may direct the UE 210 to monitor or otherwise measure (the monitored set including cells in the neighbor cell list not in the active set). The monitored set may include a subset of cells operating at the used frequency of the active set (intra-frequency), and one or more subsets of cells operating at one or more frequencies other than the used frequency (inter-frequency). In a manner similar to that by which the UTRAN maintains the active set, the UE may autonomously maintain a virtual active set for each of the other frequencies, where each virtual active set includes one or more of the monitored set cells operating at the respective frequency. A virtual active set may be treated as an active set for a respective non-used frequency.

In addition to the foregoing cells of the neighbor cell list, the UE 210 may be configured to detect and measure a number of cells that are in neither the active set nor the monitored set. This set of cells may be referred to as a detected set.

In the system, a UE 210 may be handed over between cells using the same frequency (intra-frequency handover), or between cells using different frequencies (inter-frequency handover). The UTRAN 200 may direct a UE 210 to perform intra-frequency measurements of cells of the neighbor cell list (active set, monitored set) and detected set. These intra-frequency measurements may be reported to the UTRAN to permit evaluation of the quality of the respective cells and, if appropriate, trigger an intra-frequency handover event. Similarly, the UTRAN may direct the UE to perform inter-frequency measurements of each frequency of the virtual active set(s). These inter-frequency measurements, which for each virtual active set may cover multiple cells, may be reported to the UTRAN to permit evaluation of the quality of the respective frequencies and, if appropriate, trigger an inter-frequency handover event.

As currently defined by 3GPP, a UE 210 may take or otherwise perform inter-frequency measurements of virtual active cells and monitored set cells to permit evaluation of non-used frequencies and maintain the virtual active set. The cells of these sets are included in the neighbor cell list; and as the UTRAN 200 adds or removes cells from the neighbor cell list, the UTRAN may add or remove cells from affecting the inter-frequency measurements. This may permit the network to account for scenarios such as country border areas—whereby the network operator may not want cells from another network to affect the evaluation of whether to perform an inter-frequency handover (event trigger evaluation). As the detected set cells are not included in the neighbor cell list, however, the UTRAN may not have the same level of control over those cells that may affect inter-frequency measurements. Thus, as currently defined by 3GPP, the detected set cells are not included in inter-frequency measurements.

If detected set cells are simply allowed to affect inter-frequency measurements (and hence the virtual active set and event trigger evaluation), the operator/network may not have sufficient control over which cells are allowed to affect the measurements; and in some cases, a UE 210 may trigger a measurement report to the UTRAN 200 that unnecessarily increases signaling load to the network and may result in a failed handover. It may also prevent the UE from triggering an event (e.g., reporting event) for a frequency based on a valid neighbor cell, if the event was previously triggered by a non-valid cell. Furthermore, it may be risky and complicated to modify legacy handling of the virtual active set, which may introduce unforeseen problems to the field.

As explained below, example embodiments of the present invention therefore provide cell-based inter-frequency measurement events whereby a UE 210 may be triggered to report measurements of one or more detected set cells to the network. The network may then control the addition or deletion of one or more detected set cells to the neighbor cell list based on the reported detected set cells, and thereby control the cells available for inclusion in the virtual active set. That is, the network may evaluate the reported detected set cells to determine whether to update the neighbor cell list to include one or more of the respective detected set cells. Any update to the neighbor cell list may be reported to the UE. The UE may then perform inter-frequency measurements of monitored set cells of the neighbor cell list including the respective detected set cells to permit evaluation of non-used frequencies and maintain the virtual active set. For more information on one or more manners by which the UE may report one or more detected set cells, and the network may update the neighbor cell list for subsequent use by the UE, see U.S. Provisional Patent Application No. 61/373,971, entitled: Method and Apparatus for Facilitating Controlled Updating of a Neighbor List, filed on Aug. 16, 2010, the content of which is incorporated by reference in its entirety.

As indicated above, example embodiments of the present invention provide cell-based inter-frequency measurement reporting events that may trigger a UE 210 to report measurements of one or more detected set cells when the respective detected set cells meet a triggering condition. These may be specifically designed for comparison of detected set cells to active set/monitored set cells.

Current inter-frequency measurement reporting events may be evaluated on frequency quality (not individual cell quality). Example embodiments of the present invention introduce cell-based inter-frequency events so that the network may update the neighbor cell list (CELL_INFO_LIST) with the detected cells reported via the cell-based measurement events, or perform handover to a detected set cell.

It may not be desirable to simply re-use the intra-frequency events as currently defined by 3GPP. Existing intra-frequency events are currently re-used in triggering an update to the virtual active set for a non-used frequency. That is, a UE 210 may autonomously update a virtual active set based on intra-frequency event 1a, 1b or 1c. These events are more particularly described in the aforementioned 3GPP TS 25.311.

For the intra-frequency case, it may be possible to allow detected set cells to trigger an event at the same time as active set and monitored set cells trigger the event. But for reasons explained above, this may not be possible for the inter-frequency case. Furthermore, it may be desirable to focus only on detected set cells as opposed to monitored set cells that meet the criteria since the monitored set cells may already be covered by existing virtual active set handling. That is, it may be desirable to focus on detected set cells to permit updating the neighbor cell list with one or more detected set cells, thereby allowing those detected set cells to affect existing measurement events while maintaining operator control over the cells that affect measurement reporting.

Example embodiments of the present invention provide inter-frequency events that may be evaluated with cell-based measurement and that may be triggered for a detected set cell to permit the network to update the neighbor cell list, and to thereby permit a UE 210 to efficiently perform inter-frequency measurements. Briefly, aspects of example embodiments of the present invention may be summarized as follows:
Cell-based inter-frequency measurement events (currently inter-frequency events may only exist for frequency quality evaluations).
A triggering condition focusing on detected set cells (even for intra-frequency-cell-based events, the triggering condition may not only be for detected set cells, but may instead be for a) active set cells, b) active and monitored set cells, or c) active, monitored, detected set cells). In the aforementioned cell-based inter-frequency measurement events, the detected set cell may be compared against active/monitored set cells and triggered when the triggering condition is met.
Comparison of detected set cells against virtual active set cells. The virtual active set is currently autonomously maintained by the UE, and the network is not aware of the exact content of the virtual active set at any instant in time. For intra-frequency events, the active set is explicitly maintained by the network.
As a result of the aforementioned, the network may be informed of the content of the UE maintained virtual active set.

Example embodiments of the present invention may include a second virtual active set, different form the virtual active set currently defined by 3GPP. Depending on the network configuration, the virtual active set may be equivalent to the existing virtual active set used for frequency quality estimations. The virtual active set may be a subset of the radio links in this existing virtual active set, or the virtual active set may include some/all monitored set cells. As described below, references to the “virtual active set” may refer to any of the above alternative implementations of the respective set (and not necessarily exactly equivalent to the existing virtual active set).

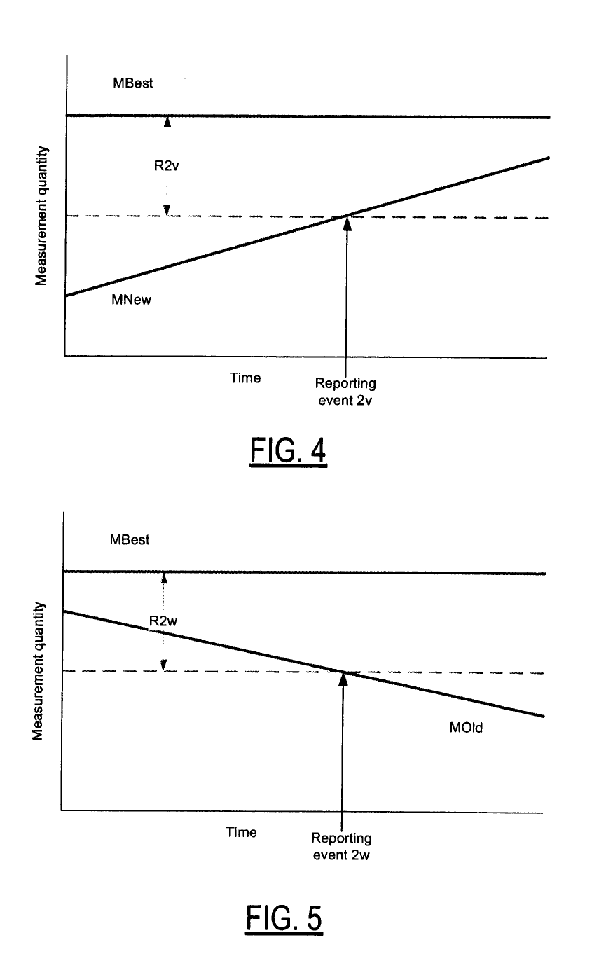

Reference will now be made to the graphs of FIGS. 4-8, which illustrate aspects of five cell-based inter-frequency measurement and reporting events, according to example embodiments of the present invention. These events may be based on respective ones of intra-frequency events 1a, 1b, 1c, 1e and 1f (see 3GPP TS 25.311). In this regard, the measurement configuration for each of the events of example embodiments of the present invention may be the same as or similar to the measurement configuration of the respective intra-frequency event on which it may be based. For purposes of illustration and without limitation, the events of example embodiments of the present invention may be referred to herein as events 2v, 2w, 2x, 2y and 2z.

Reporting Event 2v

Reporting event 2v of example embodiments of the present invention may reflect the non-used frequency primary common pilot channel (CPICH) of a cell entering a reporting range. Reporting event 2v may be based on and implemented in a manner similar to intra-frequency event 1a (see 3GPP TS 25.311, Section 14.1.2.1). The reporting range may be configured by the network, such as a range in decibels (dB) from the best cell in the virtual active set. The network may configure generic “cell specific” parameters applicable to all detected set cells (e.g., cell individual offset).

FIG. 4 shows evaluation of event 2v according to one example embodiment, where the triggering condition may be represented as follows:

$$10 \cdot {LogM}_{New} + {CIO}_{NEW} \geq W \cdot 10 \cdot Log ( {\sum }_{i = 1}^{{N}_{A}} {M}_{i} ) + ( 1 - W ) \cdot 10 \cdot {LogM}_{Best} - ( {R}_{2 v} - {H}_{2 v} / 2 )$$

In the preceding, M_{New} may represent the measurement result of the cell entering the reporting range, CIO_{New} may represent the individual cell offset for the respective cell, Mᵢ may represent the measurement result of a cell i in the same non-used frequency, and N_{A} may represent the number of cells in the same non-used frequency. Also in the preceding, W may represent a parameter received by the UE 210 from the UTRAN 200, M_{Best} may represent the highest measurement result of cells in the same non-used frequency, R₂ᵥ may represent a reporting range constant, and H₂ᵥ may represent hysteresis for event 2v. In various instances, for the sake of simplicity, one or more of the parameters time to trigger, W, CIO_{New} or H₂ᵥ may be set to zero.

Reporting event 2v may be used to determine whether a detected set cell has been measured and satisfies a certain level of cell quality by the UE 210. The respective event may also be used by the network to determine whether or not to include a reported detected set cell in the neighbor cell list or replace a monitored set cell with the detected set cell in the neighbor list. Once added to the neighbor list, the detected set cell may be considered a monitored set cell, and may be considered a virtual active set cell if/when the respective cell meets the criteria of a virtual active set cell. The cell may now be considered in the existing inter-frequency measurement event evaluation and reporting.

Reporting Event 2W

Reporting event 2w of example embodiments of the present invention may reflect the non-used frequency primary CPICH of a cell leaving the reporting range. Reporting event 2w may be based on and implemented in a manner similar to intra-frequency event 1b (see 3GPP TS 25.311, Section 14.1.2.2). This reporting event may be used to determine whether a monitored set cell leaves reporting range by the UE 210, and whether or not to exclude the cell from neighbor cell list. It is possible to maintain neighbor cell list accurately based on the UE measurement.

FIG. 5 shows evaluation of event 2w according to one example embodiment, where the triggering condition may be represented as follows:

$$10 \cdot {LogM}_{Old} + {CIO}_{Old} \leq W \cdot 10 \cdot Log ( {\sum }_{i = 1}^{{N}_{A}} {M}_{i} ) + ( 1 - W ) \cdot 10 \cdot {LogM}_{Best} - ( {R}_{2 w} - {H}_{2 w} / 2 )$$

In the preceding, M_{Old} may represent the measurement result of the cell leaving the reporting range, CIO_{Old} may represent the individual cell offset for the respective cell, R_{2w} may represent a reporting range constant, and H_{2w} may represent hysteresis for event 2w. In various instances, for the sake of simplicity, one or more of the parameters time to trigger, W, CIO_{Old} or H_{2w} may be set to zero.

Reporting Event 2X

Reporting event 2x of example embodiments of the present invention may reflect the non-used frequency primary CPICH of a cell becoming greater or otherwise better than the CPICH of a cell in the virtual active set. Reporting event 2x may be based on and implemented in a manner similar to intra-frequency event 1c (see 3GPP TS 25.311, Section 14.1.2.3). This reporting event may be used to determine whether a measured detected set cell is greater or otherwise better than a cell in virtual active set, which may suggest replacing a monitored set cell with the detected set cell in the neighbor cell list. Thus, if the network decides to add the cell to the neighbor list, the cell may immediately become part of the virtual active set, replacing one of the cells currently used in virtual active set.

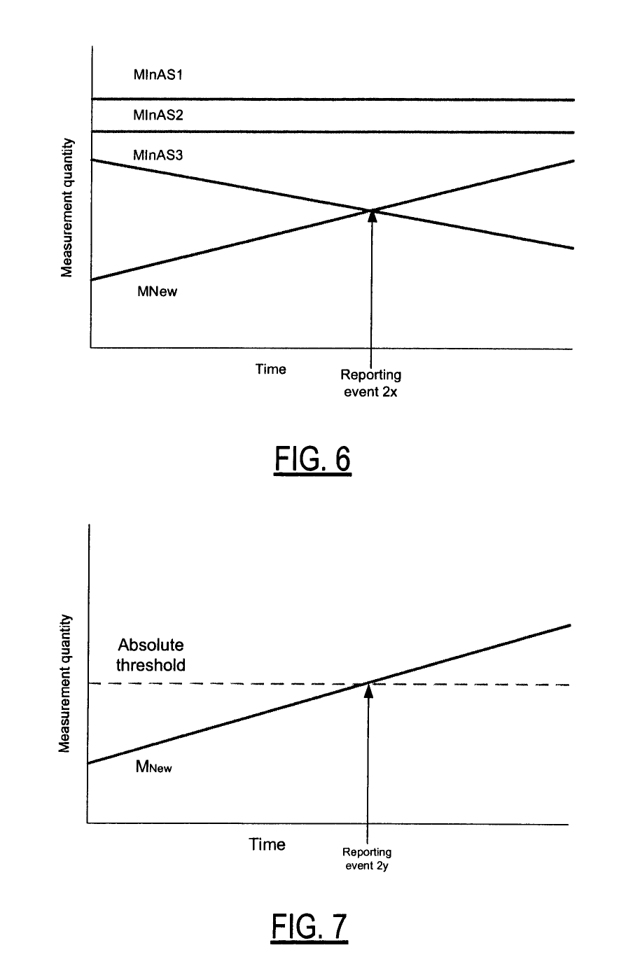

FIG. 6 shows evaluation of event 2x according to one example embodiment, where the triggering condition may be represented as follows:

10·Log M_{New}+CIO_{New}≧10·Log M_{InAS}+CIO_{InAS}+H₂ₓ/2

In the preceding, M_{New} may represent the measurement result of the cell not in the virtual active set, and CIO_{New} may represent the individual cell offset for the respective cell. Similarly, M_{InAS} may represent the measurement result of a cell in the virtual active set, and CIO_{InAS} may represent the individual cell offset for the respective cell. Also, H₂ₓ may represent hysteresis for event 2w. In various instances, for the sake of simplicity, one or more of the parameters time to trigger, CIO_{New}, CIO_{InAS} or H₂ₓ may be set to zero.

Reporting Event 2Y

Reporting event 2y of example embodiments of the present invention may reflect the non-used frequency primary CPICH of a cell becoming greater or otherwise better than an absolute threshold. Reporting event 2y may be based on and implemented in a manner similar to intra-frequency event 1e (see 3GPP TS 25.311, Section 14.1.2.5). This reporting event may be used to determine whether a measured detected set cell satisfies a certain level of cell quality by the UE 210, and whether or not to include a reported detected set cell into neighbor cell list. Additionally or alternatively, this reporting event may be used to determine whether a non-used frequency cell satisfies a certain level of cell quality to perform inter-frequency handover.

FIG. 7 shows evaluation of event 2y according to one example embodiment, where the triggering condition may be represented as follows:

10·Log M_{New}+CIO_{New}≧T_{2y}+H_{2y}/2

In the preceding, M_{New} may represent the measurement result of a cell that becomes greater or otherwise better than an absolute threshold, and CIO_{New} may represent the individual cell offset for the respective cell. Also, T_{2y} may represent an absolute threshold, and H_{2y} may represent hysteresis for event 2y. In various instances, for the sake of simplicity, one or more of the parameters time to trigger, CIO_{New} or H_{2y} may be set to zero.

Reporting Event 2Z

Reporting event 2z of example embodiments of the present invention may reflect the non-used frequency primary CPICH of a cell becoming worse than an absolute threshold. Reporting event 2z may be based on and implemented in a manner similar to intra-frequency event if (see 3GPP TS 25.311, Section 14.1.2.6). This reporting event may be used to determine whether a monitored set cell is no longer good enough to keep in the neighbor cell list, and whether or not to exclude the cell from neighbor cell list. Additionally or alternatively, this reporting event may be used to determine to stop a non-used frequency measurement.

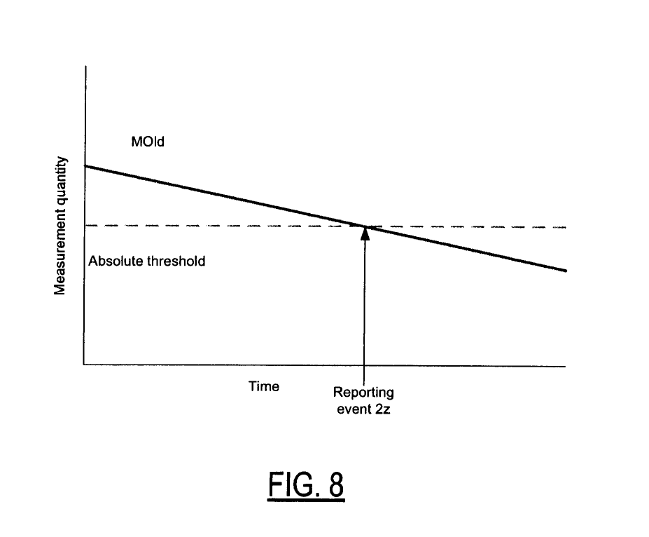

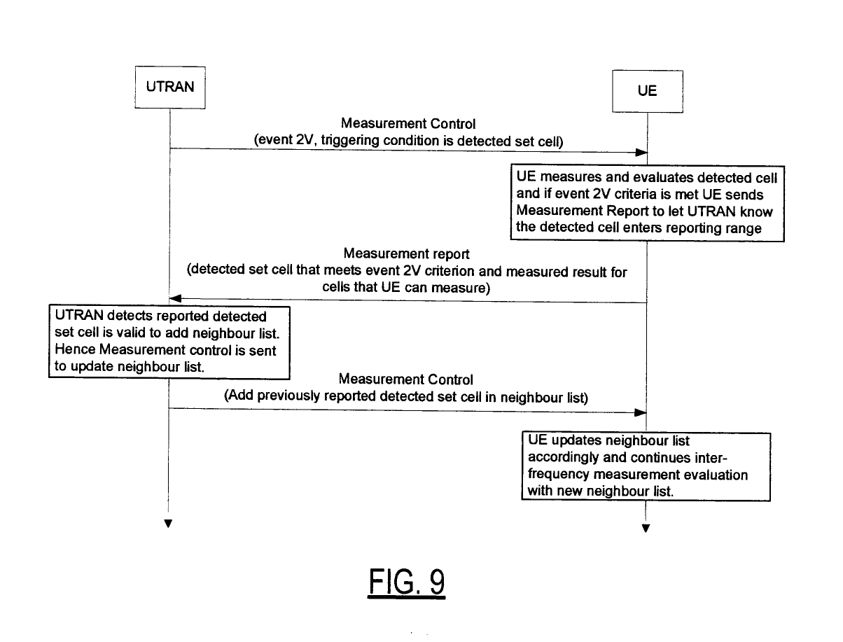

FIG. 8 shows evaluation of event 2z according to one example embodiment, where the triggering condition may be represented as follows:

10·Log M_{Old}+CIO_{Old}≧T_{2z}−H_{2z}/2

In the preceding, M_{Old} may represent the measurement result of a cell that becomes worse than an absolute threshold, and CIO_{Old} may represent the individual cell offset for the respective cell. Also, T_{2z} may represent an absolute threshold, and H_{2z} may represent hysteresis for event 2z. In various instances, for the sake of simplicity, one or more of the parameters time to trigger, CIO_{Old} or H_{2z} may be set to zero.

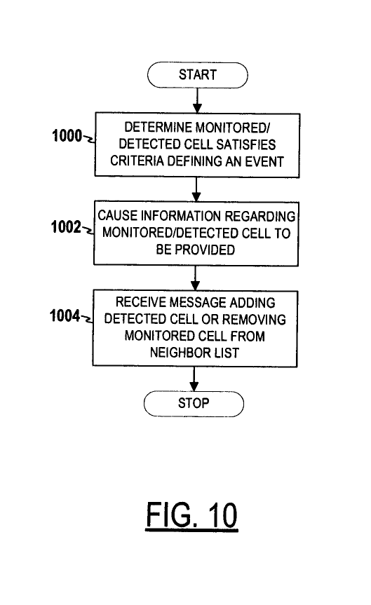

As indicated above, the network (e.g., UTRAN 200) may respond to the aforementioned cell-based inter-frequency measurement events in a number of different manners. In one example, shown in FIG. 9, the network may decide to add a detected set cell to the neighbor cell list, and/or remove a monitored set cell from the neighbor cell list. With event 2v or 2y, it may be the case that a detected set cell replaces a monitored set cell in the neighbor cell list (before the detected set cell is good enough to be in the virtual active set). With event 2w, it may be the case that a detected set cell may be immediately moved into in the virtual active set. And with event 2w or 2z, it may be the case that a monitored set cell is removed from neighbor cell list.

The above events may be configured in a measurement control message (modified to include parameters for configuration of the respective events) and the event trigger may be reported in a measurement report message (modified to report new parameters related to the respective events).

Following the report indicating that one of the aforementioned events has been triggered for a particular cell, the network (e.g., UTRAN 200) may decide whether to add the cell to the neighbor cell list. In instances in which the network decides to add the cell to the neighbor cell list, the network may modify the neighbor list using a measurement control message. The UE 210 and network may then proceed as defined by 3GPP—using virtual active set handling and frequency quality estimates to evaluate inter-frequency an event trigger, since the detected set cell has been successfully added to the neighbor list.

In a second example option for responding to a cell-based inter-frequency measurement event, the network may proceed directly to inter-frequency handover (without modifying the neighbor cell list). In these instances, the absolute threshold for event 2y may be set high enough to satisfy the condition to perform inter-frequency handover.

In a third example option for responding to a cell-based inter-frequency measurement event, the network may decide to let UE 210 to stop inter-frequency measurements. In these instances, the absolute threshold for event 2z may be set low enough to satisfy the condition to stop inter-frequency measurements. Because these events are cell-based, the network may trigger to stop inter-frequency measurement once all measured inter-frequency cells are below this threshold.

Reference is now made to FIG. 10, which presents flowchart illustrating various operations in a method that may be performed by an apparatus according to an example embodiment of the present invention. The apparatus may, in some embodiments, be a UE 140, 210. As such, the apparatus may include means, such as the processor 310, communication interface 340 (e.g., transmitter, antenna, etc.) or the like. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

As shown, the method of FIG. 10 may include determining that a monitored cell or detected cell satisfies predetermined criteria defining an event, as shown in block 1000. The monitored cell is on a neighbor list and the detected cell is not on a neighbor list, and each of the detected cell and monitored cell has a different frequency than a frequency currently in use. The method also includes causing information to be provided regarding the monitored cell or detected cell in response to the event, and receiving a message adding the detected cell to the neighbor list or removing the monitored cell from the neighbor list in response to causing the information to be provided, as shown in blocks 1002 and 1004. Once a detected cell is added to the neighbor list, the method may comprise at least one of using the detected cell to determine a frequency quality estimate, using the detected cell for inter-frequency measurements or considering the detected cell for inclusion in a virtual active set.

Examples of events according to the embodiment shown in FIG. 10 may be that a measurement of the detected cell enters a reporting range, or that a measurement of the monitored cell leaves a reporting range. Other examples of events may be that a measurement of the detected cell is greater than a threshold, or that a measurement of the monitored cell is greater than a threshold. And yet another example of an event may be that a measurement of the detected cell is greater than a corresponding measurement of another cell on the neighbor list, the respective other cell having the same frequency as the detected cell.

According to one aspect of the example embodiments of present invention, the functions performed by the apparatus 300, such as those illustrated by the control flow diagram and flowchart of FIGS. 9 and 10, may be performed by various means. It will be understood that each block or operation of the control flow diagram and flowchart, and/or combinations of blocks or operations in the control flow diagram and flowchart, can be implemented by various means. Means for implementing the blocks or operations of the control flow diagram and flowchart, combinations of the blocks or operations in the control flow diagram and flowchart, or other functionality of example embodiments of the present invention described herein may include hardware, and/or a computer program product including a computer-readable storage medium having one or more computer program code instructions, program instructions, or executable computer-readable program code instructions stored therein. In this regard, program code instructions may be stored on a memory device, such as the memory device 320 of the example apparatus, and executed by a processor, such as the processor 310 of the example apparatus. As will be appreciated, any such program code instructions may be loaded onto a computer or other programmable apparatus (e.g., processor, memory device, or the like) from a computer-readable storage medium to produce a particular machine, such that the particular machine becomes a means for implementing the functions specified in the control flow diagram and flowchart's block(s) or operation(s). These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the control flow diagram and flowchart's block(s) or operation(s). The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the control flow diagram and flowchart's block(s) or operation(s).

Accordingly, execution of instructions associated with the blocks or operations of the control flow diagram and flowchart by a processor, or storage of instructions associated with the blocks or operations of the control flow diagram and flowchart in a computer-readable storage medium, supports combinations of operations for performing the specified functions. It will also be understood that one or more blocks or operations of the control flow diagram and flowchart, and combinations of blocks or operations in the control flow diagram and flowchart, may be implemented by special purpose hardware-based computer systems and/or processors which perform the specified functions, or combinations of special purpose hardware and program code instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

1. A method comprising:
determining that a monitored cell that is on a neighbor list or a detected cell that is not on a neighbor list satisfies predetermined criteria defining an event, wherein the monitored cell or the detected cell that satisfies the predetermined criteria has a different frequency than a frequency currently in use;
causing information to be provided regarding the monitored cell or detected cell that satisfies the predetermined criteria in response to the event; and
receiving a message causing the detected cell to be added to the neighbor list or causing the monitored cell to be removed from the neighbor list in response to causing the information to be provided.

2. A method according to claim 1 further comprising using the detected cell to determine a frequency quality estimate once the detected cell has been added to the neighbor list.

3. A method according to claim 1 further comprising using the detected cell for inter-frequency measurements once the detected cell has been added to the neighbor list.

4. A method according to claim 1 further comprising considering the detected cell for inclusion in a virtual active set once the detected cell has been added to the neighbor list.

5. A method according to of claim 1 wherein determining that a detected cell that is not on a neighbor list satisfies the predetermined criteria defining an event comprises determining that a measurement of the detected cell enters a reporting range.

6. A method according to claim 1 wherein determining that a monitored cell that is on a neighbor list satisfies the predetermined criteria defining an event comprises determining that a measurement of the monitored cell leaves a reporting range.

7. A method according to claim 1 wherein determining that a monitored cell that is on a neighbor list or a detected cell that is not on a neighbor list satisfies predetermined criteria defining an event comprises determining that a measurement of the monitored cell or the detected cell is greater than a threshold.

8. A method according to claim 1 wherein determining that a detected cell that is not on a neighbor list satisfies predetermined criteria defining an event comprises determining that a measurement of the detected cell is greater than a corresponding measurement of another cell on the neighbor list, wherein the another cell has the same frequency as the detected cell.

9. An apparatus comprising at least one processor and at least one memory including computer program code, the at least one memory and the computer program code configured to, with the processor, cause the apparatus to at least:
determining that a monitored cell that is on a neighbor list or a detected cell that is not on a neighbor list satisfies predetermined criteria defining an event, wherein the monitored cell or the detected cell that satisfies the predetermined criteria has a different frequency than a frequency currently in use;
causing information to be provided regarding the monitored cell or detected cell that satisfies the predetermined criteria in response to the event; and
receiving a message causing the detected cell to be added to the neighbor list or causing the monitored cell to be removed from the neighbor list in response to causing the information to be provided.

10. An apparatus according to claim 9 wherein the at least one memory and the computer program code are further configured to, with the processor, cause the apparatus to use the detected cell to determine a frequency quality estimate once the detected cell has been added to the neighbor list.

11. An apparatus according to claim 9 wherein the at least one memory and the computer program code are further configured to, with the processor, cause the apparatus to use the detected cell for inter-frequency measurements once the detected cell has been added to the neighbor list.

12. An apparatus according to claim 9 wherein the at least one memory and the computer program code are further configured to, with the processor, cause the apparatus to consider the detected cell for inclusion in a virtual active set once the detected cell has been added to the neighbor list.

13. An apparatus according to claim 9 wherein the at least one memory and the computer program code are configured to, with the processor, cause the apparatus to determine that a detected cell that is not on a neighbor list satisfies the predetermined criteria defining an event by determining that a measurement of the detected cell enters a reporting range.

14. An apparatus according to claim 9 wherein the at least one memory and the computer program code are configured to, with the processor, cause the apparatus to determine that a monitored cell that is on a neighbor list satisfies the predetermined criteria defining an event by determining that a measurement of the monitored cell leaves a reporting range.

15. An apparatus according to claim 9 wherein the at least one memory and the computer program code are configured to, with the processor, cause the apparatus to determine that a monitored cell that is on a neighbor list or a detected cell that is not on a neighbor list satisfies predetermined criteria defining an event by determining that a measurement of the monitored cell or the detected cell is greater than a threshold.

16. An apparatus according to claim 9 wherein the at least one memory and the computer program code are configured to, with the processor, cause the apparatus to determine that a detected cell that is not on a neighbor list satisfies predetermined criteria defining an event by determining that a measurement of the detected cell is greater than a corresponding measurement of another cell on the neighbor list, wherein the another cell has the same frequency as the detected cell.

17. An apparatus according to claim 9 wherein the apparatus is embodied as a communications device.

18. An apparatus according to claim 9 further comprising:
a user interface; and
user interface circuitry configured to control at least some functions of the user interface.

19. A computer program product comprising at least one non-transitory computer-readable storage medium having computer-executable program code instructions stored therein, the computer-executable program code instructions comprising program code instructions to:
determine that a monitored cell that is on a neighbor list or a detected cell that is not on a neighbor list satisfies predetermined criteria defining an event, wherein the monitored cell or the detected cell that satisfies the predetermined criteria has a different frequency than a frequency currently in use;
cause information to be provided regarding the monitored cell or detected cell that satisfies the predetermined criteria in response to the event; and
receive a message causing the detected cell to be added to the neighbor list or causing the monitored cell to be removed from the neighbor list in response to causing the information to be provided.

20. A computer program product according to claim 19 wherein the computer-executable program code instructions further comprise program code instructions to use the detected cell to determine a frequency quality estimate once the detected cell has been added to the neighbor list.

21-26. (canceled)
